(19) United States
(12) Patent Application Publication
(10) Pub. No.: US 2022/0258920 A1
(43) Pub. Date: Aug. 18, 2022

(54) Cover for C02 cylinders

(71) Applicant: SODAPOP AUSTRIA GMBH, Wien (AT)

(72) Inventor: Roland Herrmann, Wien (AT)

(21) Appl. No.: 17/627,837

(22) PCT Filed: Jul. 20, 2020
(86) PCT No.: PCT/EP2020/070475

§ 371 Date: Jan. 18, 2022

(30) Foreign Application Priority Data
Jul. 22, 2019 (EP) 19187589.7

(51) Int. Cl. B65D 23/08; B65D 85/20

(52) U.S. Cl. CPC B65D 23/0885; B65G 2201/0244; B65D 85/20

(57) ABSTRACT

An envelope for a CO₂ cylinder, that includes a shell that forms a cavity for accommodating the CO₂ cylinder. The envelope can be accepted by an empty-container machine for taking back reusable bottles. The shell includes at least one guide rail for guiding the CO₂ cylinder into the cavity in a first direction.

### CROSS-REFERENCE TO RELATED APPLICATIONS

This application is a U.S. National Phase application under 35 U.S.C. § 371 of international Application No. PCT/EP2020/070475, filed on Jul. 20, 2020 and which claims benefit to EP Application No. 19187589.7, filed on Jul. 22, 2019.

### FIELD

The invention relates to an envelope for CO₂ cylinders, to a device with a CO₂ cylinder, and also to a method for recycling a CO₂ cylinder.

### BACKGROUND

CO₂ cylinders are gas cartridges which are filled with carbon dioxide (CO₂). For example, CO₂ cylinders are used in drinking-water carbonators to add CO₂ to tap water to produce carbonated table water (soda water). Here, the water is filled into pressure-resistant bottles and screwed to a holder of the drinking-water carbonator in a pressure-tight manner. Then, at the push of a button, the carbon dioxide is introduced into the water via a pipe and valve system, wherein the reaction of the carbon dioxide (CO₂) with water (H₂O) forms carbonic acid (H₂CO₃). The carbonic acid content in the soda water produced is determined by the duration of the introduction of the carbon dioxide.

With commercially available CO₂ cylinders which are filled with approximately 300-500 g of CO₂, up to 100 l of soda water can be produced. After a CO₂ cylinder has been emptied, it is removed from the drinking-water carbonator and then disposed of or exchanged for a filled CO₂ cylinder at certain retailers, such as for example supermarkets. For reasons of environmental protection and the reduction of waste, recycling of the CO₂ cylinders by handing in the empty cylinders at a retailer and then refilling it should be preferred to disposal of the CO₂ cylinders.

Disadvantageously, retailers such as supermarkets generally do not allow returns, but only exchange empty CO₂ cylinders for filled ones. Another disadvantage is that, for this exchange, it is necessary to contact an employee in order to hand in the empty CO₂ cylinder and obtain a filled CO₂ cylinder. In addition, the empty CO₂ cylinders are returned without packaging and without a protective envelope, and so the CO₂ cylinders may be damaged during the return and during the further handling by the employee of the retailer.

The prior art, for example U.S. Pat. No. 5,765,708 A and EP 2 682 350 A1, discloses various envelopes for cylindrical containers, in order to thermally insulate them, to transport them more easily or to make them more visually appealing. Envelopes of this kind, for example from the company TOPEAK (“TOPEAK CO2 Sleeve”), are for example also commercially available. DE 1858289 U discloses a carry pack for bottles, wherein bulge ribs are provided on the outer side. The bulge ribs serve as buffer elements and thus as a kind of breakage protection. The carry pack consists of pieces of film and can optionally also be designed for just a single bottle. Another protective envelope for bottles is disclosed in DE 6753487 U. The envelope disclosed comprises ribs which are connected to further envelopes, as a result of which an assembly of envelopes is produced.

### SUMMARY

The object of the present invention is to alleviate or eliminate at least some of the disadvantages of the known methods for returning or recycling CO₂ cylinders. The particular aim of the invention is to improve the process of returning or recycling CO₂ cylinders.

The invention provides an envelope for CO₂ cylinders, comprising a shell, wherein the shell forms a cavity for accommodating a CO₂ cylinder, wherein the envelope can be accepted by an empty-container machine for taking back reusable bottles.

This achieves the stated object.

Accordingly, the invention also provides a device with a CO₂ cylinder and an envelope for CO₂ cylinders, wherein the envelope comprises a shell and can be accepted by an empty-container machine for taking back reusable bottles, wherein the shell forms a cavity for accommodating a CO₂ cylinder, wherein the CO₂ cylinder is accommodated in the envelope.

This also achieves the stated object.

Furthermore, the invention also provides a method for recycling a CO₂ cylinder. The method comprises at least the following steps of:
introducing a CO₂ cylinder into an insertion opening of an envelope with a shell, wherein the shell forms a cavity connected to the insertion opening,
accommodating the CO₂ cylinder in the cavity;
fixing the CO₂ cylinder in the cavity; and
the envelope with the accommodated CO₂ cylinder being accepted by an empty-container machine for taking back reusable bottles.

This also achieves the stated object.

The shell of the envelope according to the invention at least partially delimits the cavity, such that a CO₂ cylinder can be accommodated and the cavity can be open. In this case, the CO₂ cylinder can protrude partially out of the cavity, such that the CO₂ cylinder is arranged at least partially in the cavity. By virtue of the fact that the envelope is designed in such a way that it can be accepted by an empty-container machine for taking back reusable bottles, the existing system of returning deposit bottles can be used to recycle CO₂ cylinders. Empty-container machines are used to take back empty beverage packaging that is subject to a deposit, such as reusable bottles or beverage cans. Here, the empty containers are scanned, weighed and automatically checked for their eligibility for return using pattern recognition. This detection of the empty containers also makes it possible for the envelope according to the invention, in which a CO₂ cylinder is accommodated, to be automatically recorded and accepted by the empty-container machine. In this case, manual recording and receipt of the empty CO₂ cylinder by an employee of the retailer is not required. Another advantage is that the accommodation of the CO₂ cylinder in the cavity of the shell protects the CO₂ cylinder more effectively from mechanical damage.

In the method according to the invention, the CO₂ cylinder is inserted into the insertion opening of the envelope and at least partially accommodated in the cavity of the shell of the envelope, said cavity being connected to the insertion opening. As a result, the CO₂ cylinder is arranged at least partially in the cavity and is fixed therein. The envelope with the CO₂ cylinder accommodated in the cavity is accepted by an empty-container machine for taking back reusable bottles. In this case, the empty-container machine is programmed to recognize and accept envelopes according to the invention with accommodated CO₂ cylinders.

According to a preferred embodiment, the envelope comprises a fixing device for fixing a CO₂ cylinder accommodated in the cavity of the shell. This makes it possible to position the CO₂ cylinder in the envelope and to prevent the CO₂ cylinder from falling out of the envelope. Due to the positioning of the CO₂ cylinder in the envelope, mechanical damage to the CO₂ cylinder can be further reduced.

For simple operation of the fixing device, it is favorable if the fixing device comprises at least one fixing hook, preferably at least two fixing hooks, particularly preferably exactly two fixing hooks, for fixing a CO₂ cylinder accommodated in the cavity. This makes it possible to produce the fixing device in a simple and cost-effective manner.

Furthermore, it is favorable if the envelope comprises an insertion opening connected to the cavity of the shell for insertion of a CO₂ cylinder into the cavity. This makes it possible for the CO₂ cylinder to be inserted via the insertion opening into the cavity in a simple manner. Advantageously, the CO₂ cylinder can be removed from the cavity again via the insertion opening in order to separate the CO₂ cylinder from the envelope.

According to a preferred embodiment, the fixing device, in particular the at least one fixing hook, is arranged on the insertion opening. This makes it possible for the CO₂ cylinder to be fixed on the insertion opening to prevent the CO₂ cylinder from falling out of the cavity via the insertion opening.

According to a particularly preferred embodiment, the fixing device, in particular the at least one fixing hook, is elastically deformable from a first position to a second position. Advantageously, when the CO₂ cylinder is being inserted into the insertion opening, the fixing device, in particular the at least one fixing hook, is elastically deformed from the first position to the second position in order to facilitate the insertion of the CO₂ cylinder. Particularly preferably, the fixing device, in particular the at least one fixing hook, returns to the first position in order to better fix the CO₂ cylinder when the CO₂ cylinder has been accommodated in the cavity.

According to a further preferred embodiment, the shell comprises at least one guide rail for guiding a CO₂ cylinder in the cavity in a first direction. As a result, the insertion of the CO₂ cylinder into the envelope can be made easier and the CO₂ cylinder can be positioned in the cavity of the shell in an exact manner.

For improved detection of the accommodation of a CO₂ cylinder, it is favorable if the envelope comprises an outlet opening connected to the cavity of the shell for the purpose of allowing the cylinder head of the CO₂ cylinder to exit out of the cavity. The outlet opening is preferably arranged on a side of the envelope lying opposite the inlet opening, such that the cylinder head of the CO₂ cylinder can exit out of the outlet opening and said CO₂ cylinder can be fixed in the cavity when the CO₂ cylinder is being inserted into the insertion opening and when it has been accommodated in the cavity.

In order to simplify the production of the envelope, it is favorable if the shell comprises a first shell part and a second shell part, wherein the first shell part and the second shell part are connected to one another, preferably are releasably connected to one another. As a result, the first and the second shell part can be manufactured separately and then the shell can be produced by connecting the first shell part to the second shell part. The first and second shell parts are particularly preferably injection-molded parts made of plastic.

Furthermore, it is favorable if the first shell part comprises at least one arresting hook and the second shell part comprises at least one corresponding accommodating opening for accommodating the at least one arresting hook of the first shell part in order to connect the first shell part to the second shell part. As a result, the first shell part can be releasably connected to the second shell part in a simple manner.

According to a particularly preferred embodiment, the second shell part comprises at least one further arresting hook and the first shell part comprises at least one further corresponding accommodating opening for accommodating the at least one further arresting hook of the first shell part in order to connect the first shell part to the second shell part. This enables an improved and more stable releasable connection between the first shell part and the second shell part.

In order to further simplify the production of the envelope, it is favorable if the first shell part and the second shell part are identical. As a result, the first and second shell parts can be produced more cost-effectively using the same machine without retooling.

According to a preferred embodiment, the shell has substantially the outer shape of a reusable bottle. As a result, the envelope can be accepted particularly easily by an empty-container machine for taking back reusable bottles.

According to a further preferred embodiment, the envelope is composed of a plastic, preferably of polypropylene. This enables a stable and resistant design of the envelope with a low weight.

It is favorable if the cavity of the shell is able to accommodate a CO₂ cylinder with a capacity of 425 g CO₂. The envelope can thus be used to accommodate commercially available CO₂ cylinders.

Furthermore, it is favorable if at least the fixing device, in particular a fixing hook, is elastically deformed from a first position to a second position as a result of the insertion of the CO₂ cylinder into the insertion opening, and the fixing device, in particular the fixing hook, returns to the first position in order to fix the CO₂ cylinder when the CO₂ cylinder has been accommodated in the cavity. This makes it possible to fix the CO₂ cylinder in the cavity of the shell in a simple manner.

### BRIEF DESCRIPTION OF THE DRAWINGS

The invention is further explained below on the basis of the non-limiting exemplary embodiment shown in the drawings:

FIG. 1 schematically shows an envelope according to the invention for CO₂ cylinders;

FIG. 2 schematically shows the envelope as per FIG. 1 with shell parts detached from one another;

FIG. 3 schematically shows the envelope as per FIG. 1 when a cylinder head of a CO₂ cylinder is being inserted into the insertion opening;

FIG. 4 schematically shows the envelope as per FIG. 1 when a cylinder body of the CO₂ cylinder as per FIG. 3 is being inserted into the insertion opening;

FIG. 5 schematically shows the device according to the invention with an envelope as per FIG. 1 and a CO₂ cylinder, as per FIG. 3, which is accommodated in the envelope;

FIG. 6 shows a detail of the device as per FIG. 5;

FIG. 7 shows a side view of the envelope and of the CO₂ cylinder as per FIG. 3;

FIG. 8 shows a side view of the device as per FIG. 5.

### DETAILED DESCRIPTION

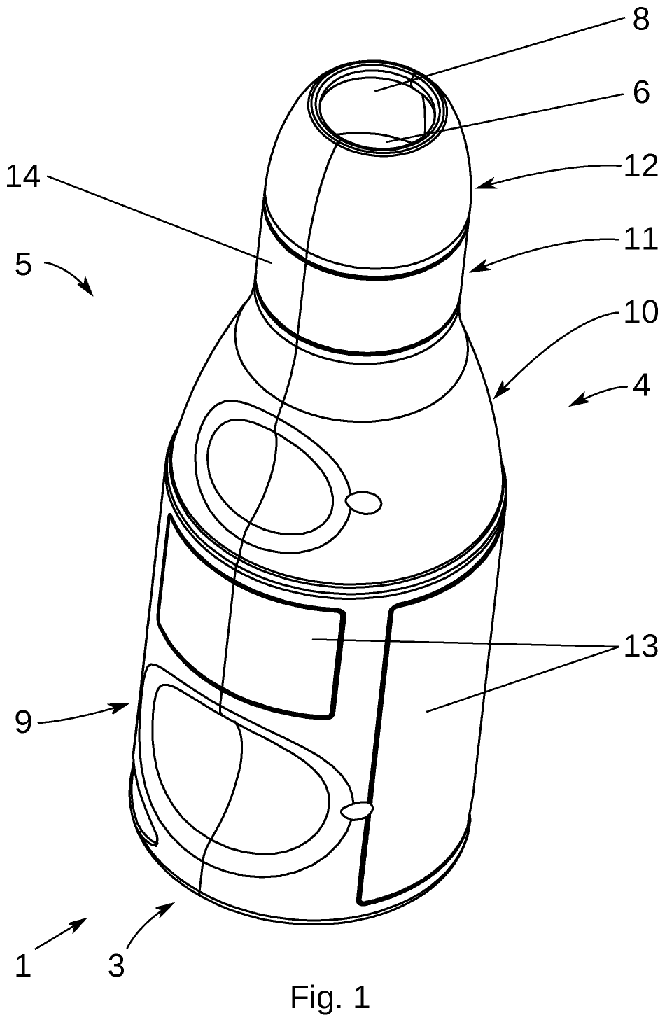

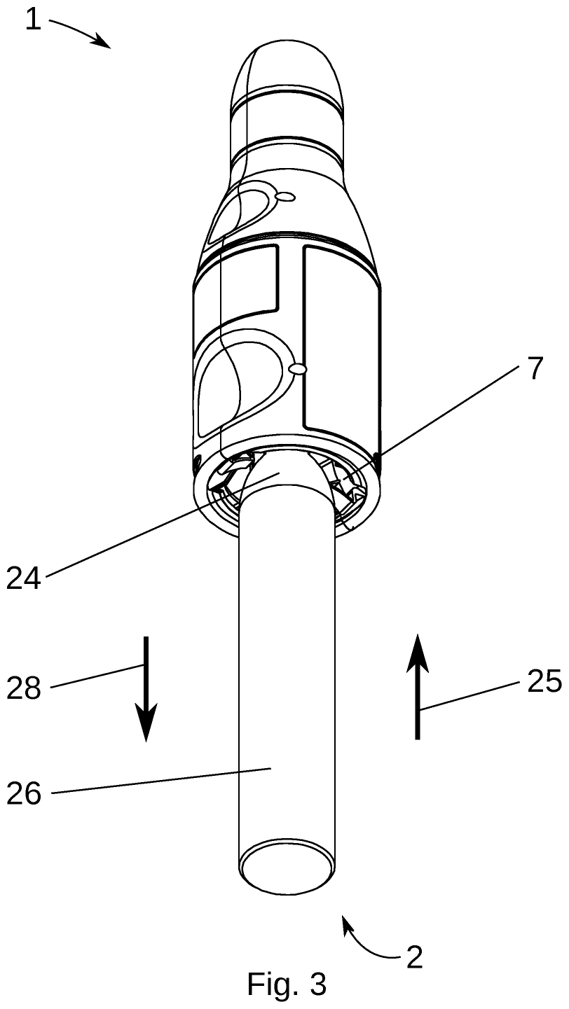

FIG. 1 shows an envelope 1 according to the invention for CO₂ cylinders 2 (see FIGS. 3-5), which comprises a shell 3. In the exemplary embodiment shown, the envelope 1 is composed of polypropylene. The shell 3 comprises a first shell part 4 and a second shell part 5, which are releasably connected to one another, wherein the shell 3 has the outer shape of a reusable bottle so that the envelope 1 can be accepted by an empty-container machine for taking back reusable bottles. When the first shell part 4 has been connected to the second shell part 5, the shell 3 forms a cavity 6 in which a CO₂ cylinder 2 can be accommodated. At the bottle base of the substantially reusable bottle-shaped shell 3, the envelope 1 comprises a substantially circular insertion opening 7 (see FIG. 3) which is connected to the cavity 6 such that the cavity 6 is open in the direction of the bottle base of the substantially reusable bottle-shaped shell 3. On an opposite side of the shell 3, at the bottle head of the substantially reusable bottle-shaped shell 3, the envelope comprises a circular outlet opening 8 which is arranged so as to be parallel to the insertion opening 7. Adjacent to the insertion opening 7, the shell 3 comprises a substantially cylindrical section 9, which is adjoined by a substantially conically converging section 10. This substantially conically converging section 10 is adjoined in the direction of the outlet opening 8 by a further substantially cylindrical section 11 and a further substantially conically converging section 12, which form the bottle neck or the bottle head of the substantially reusable bottle-shaped shell 3. The axes of rotation of the insertion opening 7, the substantially cylindrical section 9, the substantially conically converging section 10, the further substantially cylindrical section 11, the further substantially conically converging section 12 and the outlet opening 8 are identical. The shell 3 comprises four inscription surfaces 13 on the outer surface of the substantially cylindrical section 9, which have a smoother surface than the rest of the surface of the shell 3. As a result, labels, which for example show the logo of the marketer of the envelope 1, can be attached to the inscription surfaces 13. Furthermore, on the outer surface of the substantially cylindrical section 11, the shell 3 comprises a further ring-shaped inscription surface 14 with a surface which is also smoother than the rest of the surface of the shell 3, in order to attach labels.

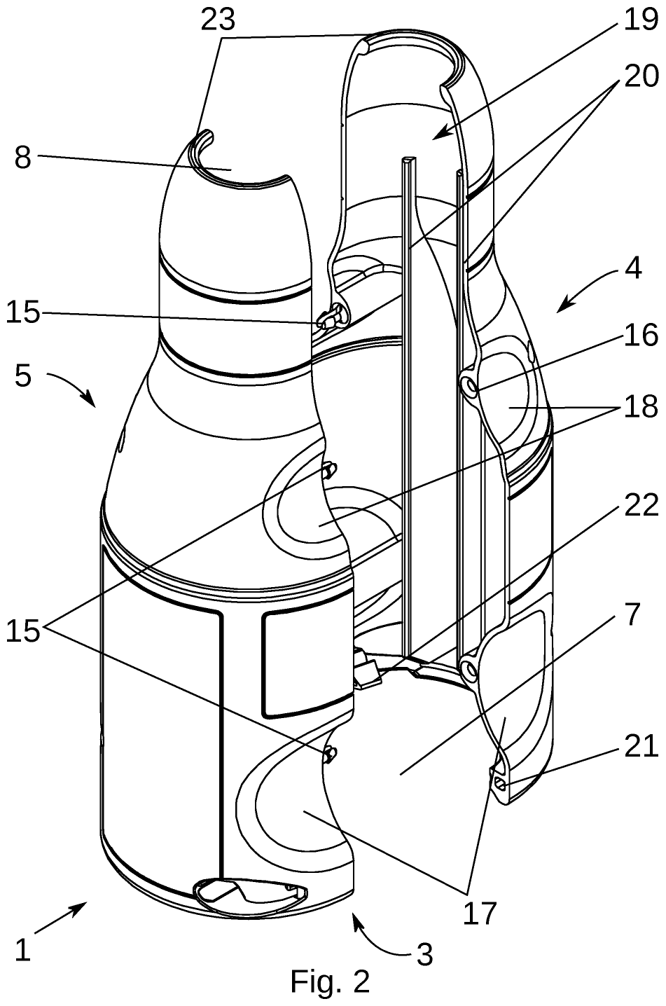

FIG. 2 shows the envelope 1 as per FIG. 1, in which the first shell part 4 has been detached from the second shell part 5. The first shell part 4 and the second shell part 5 are identical injection-molded parts made of polypropylene. The connecting surface between the first shell part 4 and the second shell part 5 runs vertically through the substantially reusable bottle-shaped shell 3 and perpendicularly with respect to the insertion opening 7 and the outlet opening 8. The first shell part 4 and the second shell part 5 comprise, in each case on the vertical connecting surface for connection to the respectively other shell part, two arresting hooks 15 which are arranged directly one above the other and two corresponding accommodating openings 16 which are arranged directly one above the other and which are intended to accommodate the arresting hooks 15. Here, in each case an arresting hook 15 and an accommodating opening 16 are arranged at a distance from one another on the vertical connecting surface, in the same horizontal plane which is parallel to the insertion opening 7, wherein this distance corresponds to the outer diameter of a commercially available CO₂ cylinder made of aluminum with a capacity of 425 g CO₂. In order to arrange the arresting hooks 15 at this distance from the accommodating openings 16 in each case, the arresting hooks 15 and the accommodating openings 16 are arranged in shell-like indentations 17 on the substantially cylindrical section 9 and in further shell-like indentations 18 on the substantially conically converging section 10. When the first shell part 4 is being connected to the second shell part 5, a respective accommodating opening 16 accommodates an arresting hook 15 in a releasable manner, such that in each case two connections of an arresting hook 15 to an accommodating opening 16 are arranged at two different distances from the insertion opening 7.

A guide rail 19, which in each case comprises two parallel rail bodies 20, is arranged on an inner surface of the first shell part 4 and of the second shell part 5 so as to in each case be parallel to the vertical connecting surface and perpendicular to the insertion opening 7. The distance between the guide rail 19 of the first shell part 4 and the guide rail 19 of the second shell part 5 also corresponds to the outer diameter of a commercially available CO₂ cylinder with a capacity of 425 g CO₂. With the aid of the mutually spaced-apart connections of the arresting hooks 15 to the accommodating openings 16 and the mutually spaced-apart guide rails 19, a commercially available CO₂ cylinder can be arranged in the cavity 8 of the shell 3 in such a way that it is delimited by the arresting hooks 15, the accommodating openings 16 and the guide rails 19 and cannot be displaced in a horizontal direction parallel to the insertion opening 7.

On a lower side of the shell 3 facing the insertion opening 7, the first shell part 4 and the second shell part 5 each have two connecting devices 21 in the vertical connecting plane, which are releasably connected to the two connecting devices of the respectively other shell part. Also on the lower side of the shell facing the insertion opening 7, the first shell part 4 and the second shell part 5 each have a fixing hook 22 which is arranged in the plane of the insertion opening 7 and protrudes into the insertion opening 7. The two fixing hooks 22 are elastically deformable and are arranged on the first shell part 4 and the second shell part 5 in such a way that, in the connected state of the two shell parts, the fixing hooks 22 are arranged on two opposite sides of the substantially circular insertion opening 7, the protrusion of the fixing hooks 22 into the insertion opening 7 having the effect that the distance between the two fixing hooks 22 is smaller than the diameter of the insertion opening 7.

On an upper side of the shell 3 facing the outlet opening 8, the first shell part 4 and the second shell part 5 have a curvature 23 which delimits the outlet opening 8 when the two shell parts are connected. When the first shell part 4 is connected to the second shell part 5, the curvatures 23 form a ring with an inner diameter that corresponds to the outer diameter of a cylinder head of a commercially available CO₂ cylinder.

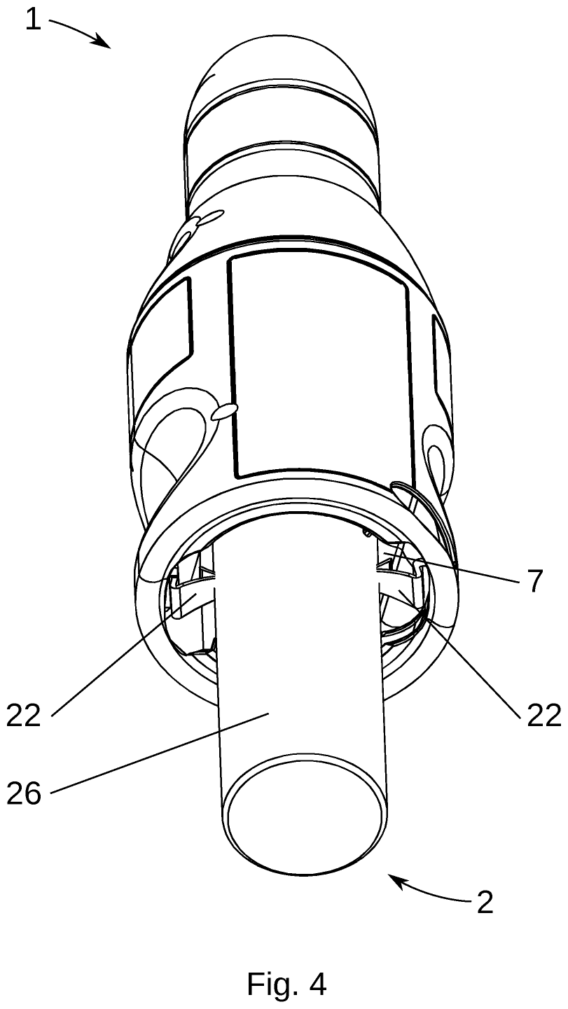

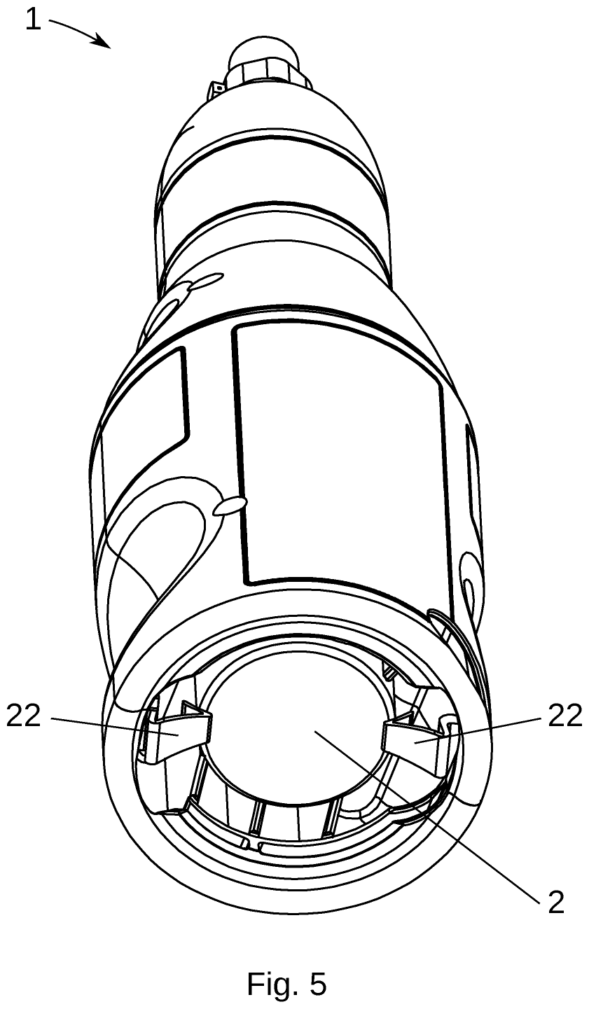

FIGS. 3 and 4 show the envelope 1 as per FIG. 1 when a CO₂ cylinder 2 is being inserted into the insertion opening 7. The CO₂ cylinder 2 is guided into the insertion opening 7 of the envelope 1 with the cylinder head 24 of the CO₂ cylinder 2 in front and is guided into the cavity 6 of the shell 3 in a first direction 25 with the aid of the guide rails 19. In this case, the first direction 25 is parallel to the rail bodies 20 of the guide rails 19 and perpendicular to the insertion opening 7. Upon further insertion of the CO₂ cylinder 2, after the cylinder head 24, the cylinder body 26 reaches the insertion opening 7, wherein when the cylinder body 26 is being inserted into the insertion opening 7, the cylinder body 26 causes the two elastically deformable fixing hooks 22 protruding into the insertion opening 7 to deform in the first direction 25 from a first position to a second position. During the insertion of the cylinder body 26 of the CO₂ cylinder 2 into the insertion opening 7 of the envelope 1, as shown in FIG. 4, in the second position the fixing hooks 22 bear against the cylinder body 26 until the CO₂ cylinder 2 has been completely inserted into the insertion opening 7 and accommodated in the cavity 6 of the shell 3. After the cylinder body 26 of the CO₂ cylinder 2 has been guided past the fixing hooks 22, the elastically deformable fixing hooks 22 return to the first position, as shown in FIG. 5. The CO₂ cylinder 2 is thus accommodated in the envelope 1, such that a device according to the invention has been formed.

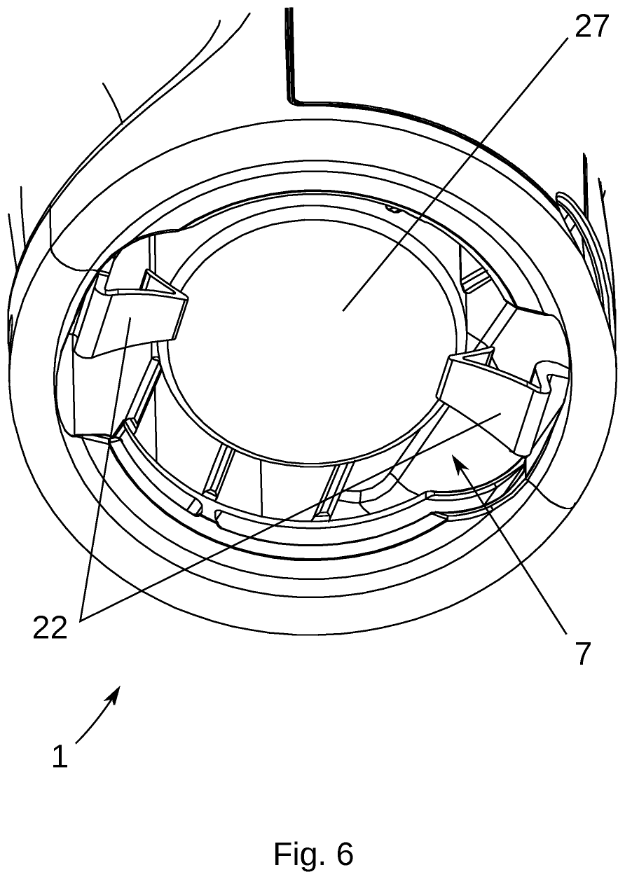

FIG. 6 shows a detail of the envelope 1 with the CO₂ cylinder 2 accommodated therein, as per FIG. 5, in the region of the insertion opening 7. A base surface 27 of the CO₂ cylinder 2 lying opposite the cylinder head 24 bears in each case against an L-shaped tab of the two fixing hooks 22. By virtue of the fact that elastic deformation of the fixing hooks 22 in a second direction 28 opposite the first direction 25 is possible only with considerable expenditure of force, the CO₂ cylinder 2 is prevented from slipping out of the cavity 6 of the shell 3 by the fixing hooks 22.

In order to remove the CO₂ cylinder 2 from the envelope 1, the fixing hooks 22 are deformed in the first direction 25 from a first position to a second position with the aid of a tool provided for this purpose or by hand in order to release the CO₂ cylinder 2 from the fixing hooks 22. The CO₂ cylinder 2 can then be moved out of the cavity 6 in the second direction 28 via the insertion opening 7. After the CO₂ cylinder 2 has exited the cavity 6, the fixing hooks 22 return from the second position to the first position, such that a CO₂ cylinder can once again be accommodated in the envelope 1.

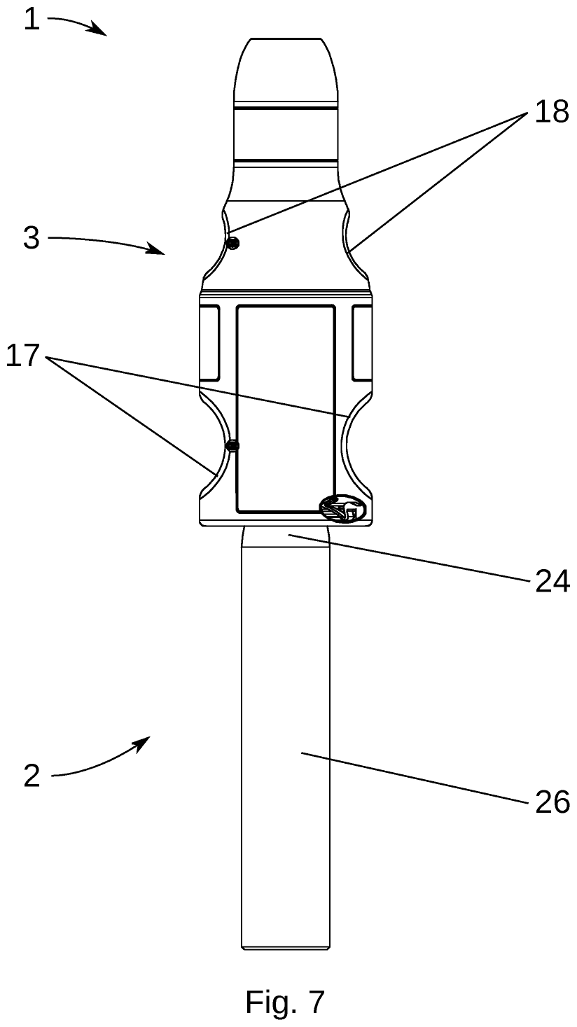

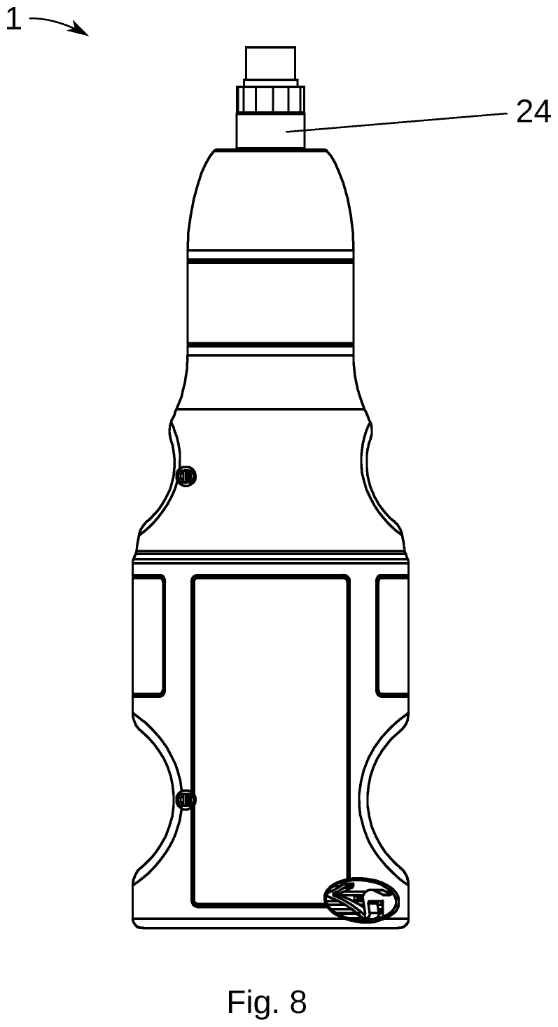

FIGS. 7 and 8 show the envelope 1 and the CO₂ cylinder 2 as per FIG. 4 and FIG. 5, respectively. As shown in FIG. 7, the shell-like indentations 17 and the further shell-like indentations 18, together with the arresting hooks 15 and accommodating openings 16 arranged on these indentations, serve to delimit the cavity 6 of the shell 3 in order to position the CO₂ cylinder 2 accommodated in the cavity 6. As shown in FIG. 8, the height of the envelope 1 is smaller than the height of the CO₂ cylinder 2, with the result that the CO₂ cylinder 2 protrudes out of the outlet opening 8 when the CO₂ cylinder 2 is fixed in the cavity 6 of the envelope 1. In this case, the height of the envelope 1 is selected such that the CO₂ cylinder 2 is fixed in the cavity 6 on the one hand between the guide rails 19, the arresting hooks 15 and the accommodating openings 16, and on the other hand between the curvature 23 and the fixing hooks 22. The CO₂ cylinder 2 arranged in the envelope 1 in this way can be accepted together with the envelope 1, due to the shape of the envelope 1, by an empty-container machine for taking back reusable bottles. By virtue of the fact that the cylinder head 24 protrudes out of the envelope 1, an empty-container machine can detect whether a CO₂ cylinder 2 is arranged in the envelope 1 and thus an improper return of empty envelopes 1 or envelopes 1 filled with other articles can be avoided.

1) An envelope for a CO₂ cylinder, comprising:
a shell, wherein the shell forms a cavity for accommodating the CO₂ cylinder, the envelope can be accepted by an empty-container machine for taking back reusable bottles, wherein the shell comprises at least one guide rail for guiding the CO₂ cylinder in the cavity in a first direction.

2) The envelope as claimed in claim 1, wherein the envelope comprises a fixing device for fixing the CO₂ cylinder in the cavity of the shell.

3) The envelope as claimed in claim 2, wherein the fixing device comprises at least one fixing hook, or at least two fixing hooks, or exactly two fixing hooks, for fixing the CO₂ cylinder in the cavity.

4) The envelope as claimed in one claim 1, wherein the envelope comprises an insertion opening connected to the cavity of the shell for inserting of the CO₂ cylinder into the cavity.

5) The envelope as claimed in claim 4, wherein the envelope comprises at least one fixing hook for fixing the CO₂ cylinder in the cavity, wherein the at least one fixing hook is arranged on the insertion opening.

6) (canceled)

7) The envelope as claimed in claim 1, wherein the envelope comprises an outlet opening connected to the cavity of the shell for allowing a cylinder head of the CO₂ cylinder to exit out of the cavity.

8) The envelope as claimed in claim 1, wherein the shell comprises a first shell part and a second shell part, wherein the first shell part and the second shell part are connected to one another, or are releasably connected to one another.

9) The envelope as claimed in claim 8, wherein the first shell part comprises at least one arresting hook and the second shell part comprises at least one corresponding accommodating opening for accommodating the at least one arresting hook of the first shell part to connect the first shell part to the second shell part.

10) The envelope as claimed in claim 8, wherein the first shell part and the second shell part are identical.

11) The envelope as claimed in claim 1, wherein the shell has substantially an outer shape of a reusable bottle.

12) The envelope as claimed in claim 1, wherein the envelope is composed of a plastic or of polypropylene.

13) A device comprising the envelope of claim 1 and the CO₂ cylinder, wherein the CO₂ cylinder is accommodated in the envelope.

14) A method for recycling a CO₂ cylinder, comprising the following steps of:
introducing the CO₂ cylinder into an insertion opening of an envelope with a shell, wherein the shell forms a cavity connected to the insertion opening;
accommodating the CO₂ cylinder in the cavity;
fixing the CO₂ cylinder in the cavity; and
wherein the envelope with the accommodated CO₂ cylinder being accepted by an empty-container machine for taking back reusable bottles.

15) The method as claimed in claim 14, wherein the envelope comprises at least one fixing device that is elastically deformed from a first position to a second position as a result of the introducing step, and the at least one fixing device returns to the first position in to fix the CO₂ cylinder when the CO₂ cylinder has been accommodated in the cavity.

16) The envelope as claimed in claim 8, wherein an inner surface of the first shell part and/or the second shell part comprises two rail bodies, wherein a distance defined between the two rail bodies corresponds to an outer diameter of the CO₂ cylinder.

17) The envelope as claimed in claim 3, wherein the at least one fixing device is elastically deformed from a first position to a second position during insertion of the CO₂ cylinder into the envelope, wherein the at least one fixing device returns to the first position after the CO₂ cylinder has been positioned inside of the cavity.

18) The envelope as claimed in claim 17, wherein at least one fixing hook comprises an L-shaped tab against which a base surface of the CO₂ cylinder bears when the CO₂ cylinder is in the envelope.

19) The envelope as claimed in claim 1, wherein the envelope comprises two fixing hooks, each having an L-shaped tab against a surface of the CO₂ cylinder bears when the CO₂ cylinder is in the envelope, wherein the two fixing hooks generally oppose one another.

20) The envelope as claimed in claim 19, wherein the envelope comprises an insertion opening at a bottom end of the envelope, the two fixing hooks each extend from an inner wall defining the insertion opening and are angled towards a top end of the envelope.

21) The envelope as claimed in claim 1, wherein the envelope comprises a bottom end and an opposing top end, the bottom end comprises an insertion opening through which the CO₂ cylinder is inserted into the envelope, the top end of the envelope comprises an outlet opening through which a top end of the CO₂ cylinder protrudes when the CO₂ cylinder is in the cavity.
